(19) United States
(12) Patent Application Publication
(10) Pub. No.: US 2013/0337853 A1
(43) Pub. Date: Dec. 19, 2013

(54) SYSTEM AND METHOD FOR INTERACTING WITH A MOBILE COMMUNICATION DEVICE

(71) Applicant: Talkler Labs, LLC, Belmont, MA (US)

(72) Inventors: Jeffrey Korn, Belmont, MA (US); Alex Lynch, Lawrenceville, GA (US)

(21) Appl. No.: 13/921,586

(22) Filed: Jun. 19, 2013

Related U.S. Application Data
(60) Provisional application No. 61/661,792, filed on Jun. 19, 2012.

(51) Int. Cl. H04W 4/12

(52) U.S. Cl. CPC H04W 4/12
USPC 455/466

(57) ABSTRACT

Various techniques and supporting systems for presenting an audible and visual representation of a message delivered onto a mobile device are described. In one embodiment, an incoming electronic message comprising at least one textual component is received at a mobile device. Characteristics of the message are audibly presented to a user of the device, who in turn provides a user comment indicating a desired operation for the incoming message. The textual component of the message is translated into an audio stream and visually presented in synchronicity with the audio stream such that text corresponding to a currently audible portion of the textual component is presented substantially central of the display using a first set of display characteristics, and text not corresponding to the currently audible portion of the textual component is presented using a second set of display characteristics.

### CROSS-REFERENCE TO RELATED APPLICATIONS

This application claims priority to and the full benefit of U.S. Provisional Patent Application No. 61/661,792, filed on Jun. 19, 2012, the disclosure of which is incorporated by reference in its entirety.

### FIELD OF THE INVENTION

The invention relates generally to methods and supporting systems for acoustically and verbally interacting with a mobile communication device, and more specifically, techniques that facilitate the interaction with content on a mobile device in a hands-free and eyes-free manner.

### SUMMARY OF THE INVENTION

Embodiments of the invention provide techniques and systems that allow a user of mobile devices to view, review and otherwise interact with messages received on a mobile device in a manner that does not distract the user from other tasks. For example, a user of a mobile device may be driving and have placed their device in a cradle or other receptacle within the driver's area and be receiving email messages. But, for safety's sake, the user does not wish to take his hands off the steering wheel to open the email, nor does he wish to take his eyes off the road in order to glance at the device. Instead, the systems and methods described herein provide an application that may, for example, automatically translate header information of the message into an audible signal, and also present an audible representation of the message to the user. In addition, a visual representation of the message is presented in a manner that makes it easier to view contents of the message without having to scan the device for any significant period of time.

As such, in a first aspect, embodiments of the invention provide a method for presenting an audible and visual representation of a message delivered onto a mobile device. The method includes receiving an incoming electronic message that comprises at least one textual component at the mobile device and audibly presenting one or more characteristics of the incoming message. An audible user command indicating user interest in the incoming message is received indicating an operation that is to be performed on the message. The textual component is translated into an audio stream which is visually presented in synchronicity with the textual component. The audio stream and visual presentation are synchronized such that as the textual component scrolls across a display of the mobile device the text corresponding to a currently audible portion of the textual component is presented substantially central of the display using a first set of display characteristics, and text not corresponding to the currently audible portion of the textual component is presented using a second set of display characteristics.

In certain embodiments, the incoming message may be a text (e.g., SMS) message whereas in other cases it may be an electronic mail message. The characteristics of the incoming message that are presented to the user may be, for example, the time of receipt of the message, the subject of the message, and/or the name of the sender of the message. The audible user command may include a command to read the message, a command to delete the message, a command to mark the message as read, or a command to mark the message as unread. In some implementations, the visually presented textual component is limited to a specified number of lines of text, whereas in other cases the textual component may be limited to a specified number of words. In yet other embodiments, the visually presented textual component is limited to a specified amount of time required to audibly present the textual component .

In some versions, the text corresponding to a currently audible portion of the textual component may be a single word, a single horizontal line of text, or multiple horizontal lines of text. The first set of characteristics may be a selected font size, a selected font type, a selected font color, or a selected background color, and the second set of characteristics may be at least one modified characteristic from the first set of characteristics. In one particular example, the modified characteristic from the first set of characteristics is implemented as a gradient shadow effect such that the text not corresponding to the currently audible portion of the textual component is presented in a darker font color than the text corresponding to a currently audible portion of the textual component.

In another aspect, embodiments of the invention provide a system for presenting an audible and visual representation of a message delivered onto a mobile device. The system provides a set of computer-executable instructions, which may be stored on a memory and executed by a processor. When executed, the instructions cause the instantiation of a message presentation application that presents an audible and visual representation of the message. The application receives an incoming electronic message comprising at least one textual component and audibly presents a characteristic of the incoming message to the user of the device. The application receives an audible user command indicating an operation to be performed on the incoming message and translates the textual component to an audio stream. The application further visually presents the textual component in synchronicity with the audio stream. The audio stream and visual presentation are synchronized such that as the textual component scrolls across a display of the mobile device the text corresponding to a currently audible portion of the textual component is presented substantially central of the display using a first set of display characteristics, and text not corresponding to the currently audible portion of the textual component is presented using a second set of display characteristics.

In certain embodiments, the incoming message may be a text (e.g., SMS) message whereas in other cases it may be an electronic mail message. The characteristics of the incoming message that are presented to the user may be, for example, the time of receipt of the message, the subject of the message, and/or the name of the sender of the message. The audible user command may include a command to read the message, a command to delete the message, a command to mark the message as read, or a command to mark the message as unread. In some implementations, the visually presented textual component is limited to a specified number of lines of text, whereas in other cases the textual component may be limited to a specified number of words. In yet other embodiments, the visually presented textual component is limited to a specified amount of time required to audibly present the textual component .

In some versions, the text corresponding to a currently audible portion of the textual component may be a single word, a single horizontal line of text, or multiple horizontal lines of text. The first set of characteristics may be a selected font size, a selected font type, a selected font color, or a selected background color, and the second set of characteristics may be at least one modified characteristic from the first set of characteristics. In one particular example, the modified characteristic from the first set of characteristics is implemented as a gradient shadow effect such that the text not corresponding to the currently audible portion of the textual component is presented in a darker font color than the text corresponding to a currently audible portion of the textual component.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 is a diagrammatical illustration of a mobile communication device with the disclosed Software Application, in accordance with the present invention;

FIG. 2 is an illustration of a message list as may be presented on the display screen of the mobile communication device of FIG. 1;

FIGS. 3A and 3B illustrate a flow diagram illustrating operation of the Software Application, in accordance with the present invention;

FIG. 4 is an illustration of the message list of FIG. 2 including a microphone icon;

FIG. 5 is an illustration of message text from a message selected from the message list of FIG. 2;

FIG. 6 is an illustration of the message text of FIG. 5 showing gradient shadows overlaying portions of the message text;

FIG. 7 is an illustration of the message text of FIG. 5 showing text size and line spacing used in the message text; and

FIG. 8 is a flow diagram illustrating operation of a method for synchronizing the scrolling of text on the display screen of FIG. 1 with the voicing of the text by a text-to-speech engine.

### DETAILED DESCRIPTION OF THE INVENTION

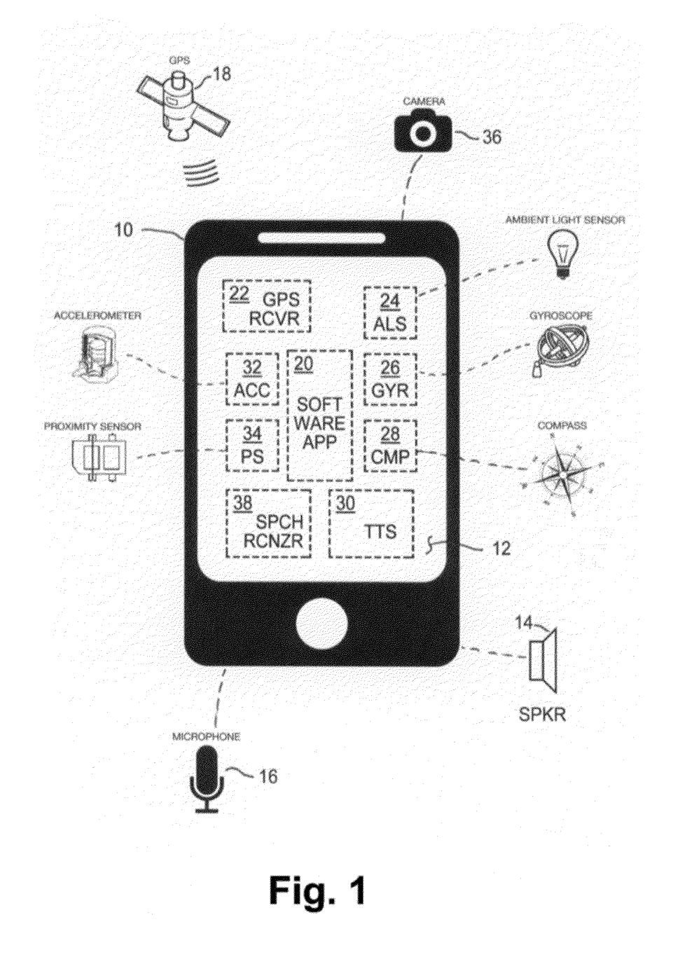

FIG. 1 is an illustration of a mobile communication device 10, such as an IPHONE, a SMARTPHONE, an ANDROID, or a BLACKBERRY. The mobile communication device 10 may include numerous features for personal and professional communication, such as telephony, electronic mail, short messaging services (i.e., texting), video conferencing, and the like. The communication media may include text, audio and/or video. The device 10 may also include a cradle (not shown) or other physical mounting unit that supports the mobile communication device 10 in view of the user. Such a configuration allows the user to operate the mobile communication device 10 in an essentially hands-off and eyes-free mode, such as attached to an element of a vehicle such as a windshield, a dashboard, or handlebars, or a piece of furniture, such as a desk, cabinet, or counter.

The mobile communication device 10 may include a Software Application 20, in accordance with an exemplary embodiment of the present invention. The Software Application 20 may be configured to act as an email or text messaging client on the device 10, such that it periodically queries (or receives) incoming emails or text messages from a conventional message service. The Software Application 20 functions in conjunction with a speech recognizer 38 to enable the user to listen to and interact with the mobile communication device 10, as described in greater detail below. In an exemplary embodiment, the user may interact with the mobile communication device 10 by selectively glancing at a display screen 12, listening to a speaker 14 in the mobile communication device 10, and providing verbal prompts to a microphone 16 in the mobile communication device 10.

A typical mobile communication device may include one or more internal sensors to enhance functionality and provide additional features to the user. For example, the mobile communication device 10 may include one or more of: (i) a GPS receiver 22 for receiving positioning signals from one or more GPS satellites 18, (ii) an ambient light sensor 24 for detecting ambient light conditions, (iii) a gyroscope 26 for detecting device rotation, (iv) a compass 28 for detecting device orientation, (v) an accelerometer 32 for detecting device movement, and (v) a proximity sensor 34 for detecting the presence of nearby objects. The mobile communication device 10 may also include a built-in camera 36 for obtaining digital images and/or video.

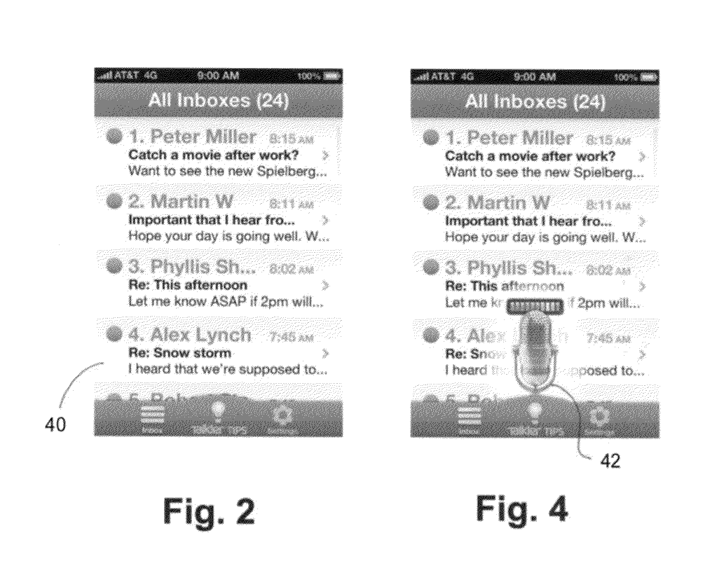

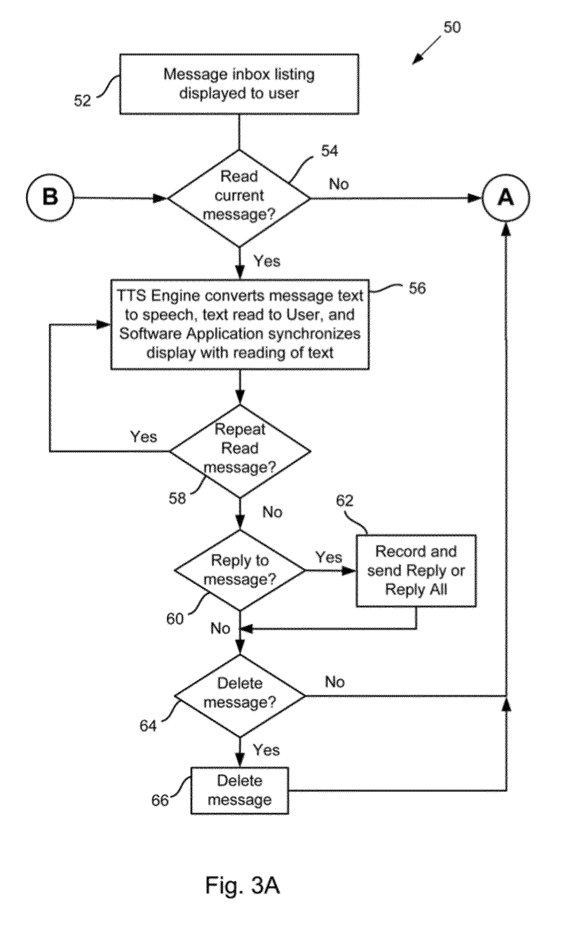

FIG. 2 shows a message inbox listing 40 as may be displayed in the display screen 12, as provided in step 52 of a flow diagram 50 shown in FIG. 3. In an exemplary embodiment, the Software Application 20 may function in conjunction with a text-to-speech (TTS) engine 30 and the speaker 14 to audibly inform the user of: (i) the time of receipt, (ii) the sender, (iii) the message subject, and/or (iv) other header information, for an incoming e-mail message, or other received communication.

While the examples and illustrations provided herein describe the invention with respect to “messages” the inventive techniques and systems may be used to present any form of structured content to the user. For example, a document drafted using a commercial word processing application or platform such as MICROSOFT WORD or GOOGLE DOCS may include tags or fields that include data, which may be processed according to the techniques described below. Likewise, a web page may include elements such as a title, headers, and other structural elements that can be captured and used as input into the Software Application 20. Likewise, a calendar event may include elements such as a title, location, start and end dates, invitees, and notes, conference dial in number, organizer, as well as other information which may be processed according to the techniques described below. Similarly, a news story may include elements such as a headline, byline, body text and source publication, which may be processed according to the techniques described below.

The TTS engine 30 and the speaker 14 thus operate in conjunction with a visual display on the display screen 12, where the visual display provides a text display that is synchronized with the audio being generated by the TSS engine 30 and emitted by the speaker 14. As can be appreciated by one skilled in the art, text-to-speech technology is imperfect, and providing a synchronous teleprompter display in this manner allows the user to view words, such as proper names, which the text-to-speech technology might be mispronouncing. The user needs only to selectively glance at the text display in the display screen 12, and is thus not required to view the mobile communication device 10 for any significant period of time or continually in order to receive and understand the message.

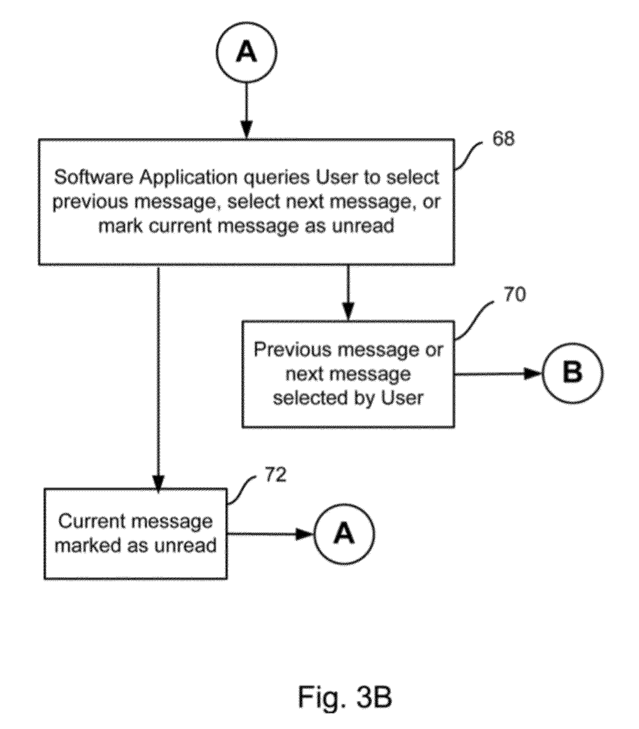

For example, the mobile communication device 10 may output, via the speaker 14, an audio statement such as “You have an unread message from Peter Miller, received at 8:15 AM.” A microphone icon 42 may appear in the message inbox listing 40, as shown in FIG. 4, to indicate that the Software Application 20 is ready to accept verbal instructions from the user. The mobile communication device 10 may also be directed by the user to “read out loud” the body of a selected message in the message inbox listing 40, at decision block 54.

Examples of other commands that may be given by the user and processes by the Software Application 20 include, but are not necessarily limited to: “Check for new mail”, “Play my (unread) emails”, “Show just unread emails”, “Show both read & unread emails”, “Go to sleep”, “Cancel” or “Do nothing”, “Go to the top (or bottom) of list”, “Read email number X”, “Help me”, “Play the next email”, “Read the previous message”, “Delete this email”, “Reply” or “Reply All”, “Jump forward a bit”, “What was that?”, “Restart this email”, “Mark this email as Unread”, “Pause reading”, “Continue playing this email”, “Speak more slowly (or quickly)”, “Return to the Inbox”, and “Go to sleep.”

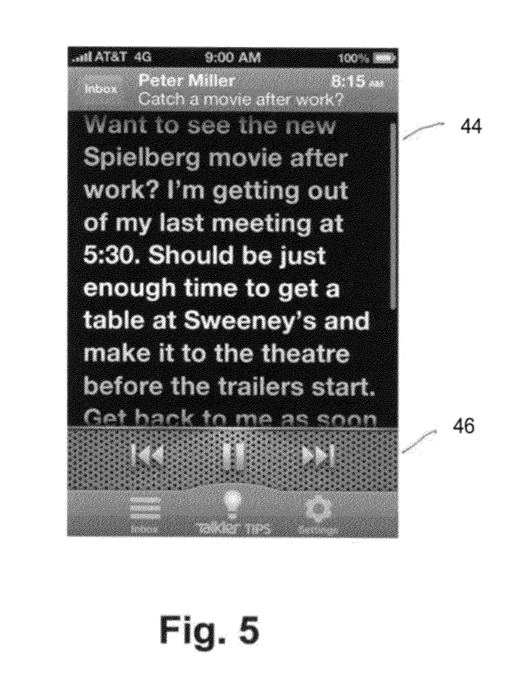

If the user has elected to have the selected message read, the TTS engine 30 converts a portion of the message text to audible speech, at step 56. In the example provided, the user has selected the first message, as shown in FIG. 5, although the user can select any message, as described in greater detail below. The display screen 12 displays the initial portion of the message 44 along with control buttons 46. The TSS engine 30 converts the message text to speech, and the Software Application 20 displays the message text on the display screen 12 in synchronicity with the audio generated by the TTS engine 30.

It should be understood that the Software Application 20 functions by identifying discrete portions of text. As used herein, a discrete text portion comprises: (i) a sentence as indicated by a terminus (period) or question mark or exclamation point or equivalent, (ii) a line of text as indicated by a line break, or (iii) a word. Accordingly, sentences may be used to define discrete portions of text so as to enable the TTS engine 30 to interpret and naturally voice grammatically intact phrases.

In some embodiments, the display screen 12 may present the message text in oversized letters and/or in a high-contrast manner, so that the selected message can be viewed and comprehended quickly and safely. The scrolling movement of the message text on the display screen 12, is similar to the scrolling action of a teleprompter, and is synchronized to the voicing of the text by the TTS engine 30. The size and pace of the visual display on the display screen 12 are preferably made to allow the user to safely locate any questionable word or phrase on the display screen 12, moments after the unclear word or phrase has been voiced by the TSS engine 30.

Portions of the text displayed on the display screen 12 may be classified into one of two types—text corresponding to the currently output audio, and text not corresponding to the audio. The text corresponding to the audio may be the current word, phrase, sentence, line or set of lines depending, for example, on user-specified options. The text not corresponding to the audio may be the words, phrases, lines or sentences preceding and/or following the text corresponding to the audio. In this example, as the text scrolls across the display, the text not corresponding to the audio that has already been audibly presented to the user moves off the screen, the text corresponding to the current audio moves from an area below the central portion of the screen to the middle of the screen, and new text, not yet presented audibly, appear at the bottom of the screen. As can be recognized, the direction or orientation of the scrolling relative to either the user or the device itself is not germane to the invention and in fact the scrolling may be bottom to top (as described above), top to bottom, left to right, or right to left. In some instances, the scrolling direction and orientation may be selected by the user, and, in further embodiments, may change as the orientation of the device changes or as the language of the text being displayed changes.

In certain cases, characteristics of the two groups of text may differ to further enhance the visual recognition of the text being output. The characteristics may include the font type, font size, font color, background color, underlining, boldface, italics, etc. To enhance readability and to focus the user's glance at the text relating to the currently-playing audio, one or more of these characteristics may differ between the text not corresponding to the audio and the text corresponding to the audio.

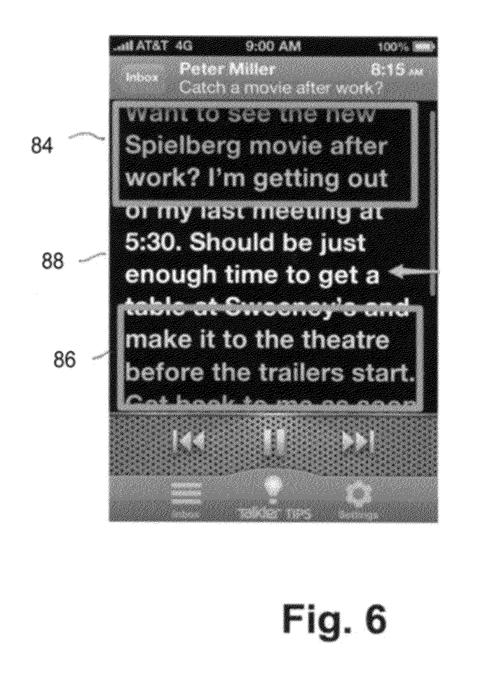

For example, gradual (i.e., gradient) shadows may be overlaid onto the scrolling text, and anchored to the top 74 and the bottom 76 of the scrolling text area on the display screen 12, as shown in FIG. 6. This configuration is provided so as to enable the user to identify the Current Speech Location 78, that is, the line or lines of message text currently being voiced by the TTS engine 30. This configuration solves two problems. The first problem solved is the method of visually directing the user to a word or line of text that is in motion, as the text of the teleprompter screen configuration scrolls upward within the display screen 12. The second problem solved is that of identifying a line of text without adding visual distraction to the display screen 12.

Referring again to FIG. 3A, the user may request that the Software Application 20 repeat the selected message, as decision block 58. The process returns to step 56 and the selected message is repeated. Otherwise, the user may decide whether to reply to the selected message, at decision block 60. If so, the Software Application 20 records the user's response, at step 62, and sends the audio file to one or more recipients having addresses listed in the selected message.

If the user elects to not respond to the selected message, at decision block 60, the user may decide to delete the selected message, at decision block 64. If not, the process moves to step 68, shown on FIG. 3B. If the message is deleted, at step 66, the Software Application 20 queries the user whether to move to another message, at step 68. The user may elect to move ahead to the next message, or to move back to the previous message, at step 70. The process then returns to decision block 54 where the user may decide whether or not to read the currently-selected message.

If the user decides to mark the current message as unread, at step 72, the user may be queried by the Software Application 20, at step 68, as to whether another message is to be selected. If the user does not elect to have the message read, at decision block 54, the user may be queried by the Software Application 20, at step 68, as to whether the current message is to be marked unread.

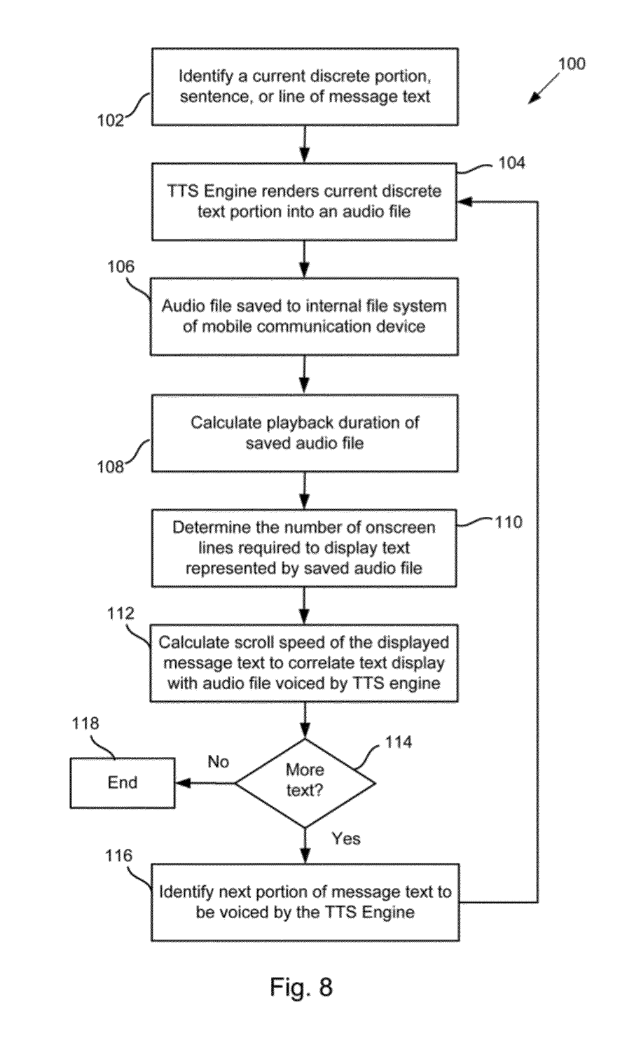

In an exemplary embodiment, a method for synchronizing the scrolling of text on the display screen 12 with the corresponding voicing of the text by the TTS engine 30 may be described with reference to a flow diagram 100, in FIG. 8. A selected portion of a sentence or line of the current message is identified by the Software Application 20, at step 102. The TTS engine 30 renders the selected portion of the message into an audio file, at step 104. In an exemplary embodiment, the audio file may be saved to a memory or other internal filing system in the mobile communication device 10, at step 106.

The playback time of the selected message portion is calculated, at step 108. From this calculation, the Software Application 20 determines an approximate number of onscreen lines that may be required to display the text corresponding to the audio file obtained from the selected message, at step 110. From this determination, an appropriate scroll speed is determined for the lines of message to be displayed on the display screen 12, at step 112. By way of example, if the duration of an audio file is five seconds, and the portion of text occupies two lines on the display screen 12, then an appropriate scroll speed may allow about two to three seconds for viewing each line of message text.

If there is additional, unread text in the currently-selected message, determined at decision block 114, a subsequent portion of the current message is identified, at step 116, and the subsequent message portion is similarly rendered into an audio file, at step 104. Otherwise, when the end of the current message has been reached, the process ends, at step 118.

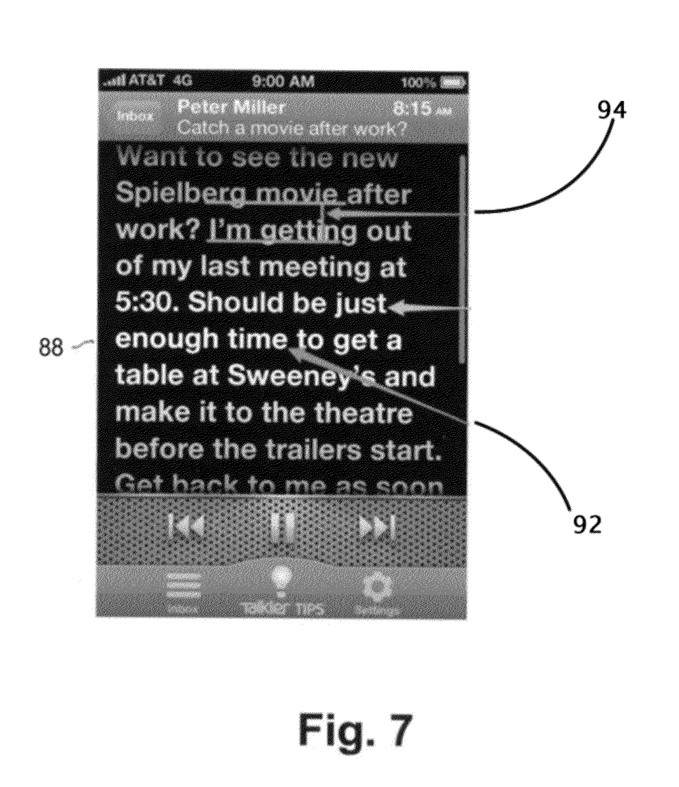

In an exemplary embodiment, shown in FIG. 7, white type 82 is displayed on a black background, to ensure that the text stands out as the most prominent element on the display screen 12, for easy at-a-glance recognition. This enhancement also solves the problem of use of the system while driving at night, when a white background would be too bright and would cause dangerous glare directed toward the user operating a vehicle, making it difficult to see a dark landscape outside the vehicle. For this reason, most automobile dashboards use a dark background, with bright foreground information (e.g., a speedometer). The disclosed system applies the same logic to the teleprompter-style presentation on the display screen 12 for safe use in vehicles.

Line spacing 84 of the message text in the scrolling teleprompter-style presentation may be designed to keep three to four lines of text (i.e., about sixteen words) on the display screen 12 above the Current Speech Location 78. Sixteen words is typically about five seconds' worth of message text voiced by the TTS engine 30. This solves two problems. The first problem solved is that of the message text being too tightly compressed on the display screen 12 such that the compressed words may be difficult to recognize when glanced at.

The second problem solved is the problem of lines of message text being too widely spread, such that a questionable word has already left the display screen 12 before the user has an opportunity to glance at the display screen 12 and spot the questionable word. The second problem is solved by providing appropriate line spacing and text size. For example, in one embodiment, the words will have an onscreen persistence of approximately five seconds after being voiced by the TSS engine 30, which is an optimal time window to allow the user to glance back to the display screen 12 after hearing the questionable word. In some instances the number of words and/or lines of text may be limited to ensure that a user can review a previously spoken word or phrase within a specified amount of time. The amount of time may be automatically set by the Software Application 20, or may be selected by the user.

The Software Application 20 may further function, via the speaker 14, to audibly ask the user how to respond to the displayed message by outputting another audio statement. For example, the mobile communication device 10 may ask the user “What would you like to do next?” The user may respond via the microphone 16 and the speech recognizer 38 by saying or uttering, for example, “Delete this message,” at decision block 60. If the message is deleted, at step 62, the Software Application 20 then proceeds to decision block 68.

If the user has elected to not delete the current message, at decision block 60, the user may instead decide to reply to the current message, at decision block 64. The Software Application 20 may then function to record and send a reply, at step 66, and may then proceed to decision block 68 after the reply is sent. At decision block 68, the user may respond by asking the Software Application 20 to go to the next message, and the process returns to step 58. Otherwise, the Software Application 20 may wait for further instruction, at step 70.

As can be appreciated, the user experience is designed to be similar to calling a personal assistant or a trusted friend, and asking the assistant or friend to read to the user the received message or communication. The resultant interaction between the user and the mobile communication device 10 is thus conversational and intuitive.

In addition to “reading” e-mail messages, the Software Application 20 may further provide to the user dynamic text-based information such as, for example, any one or more of: (i) news headlines, (ii) SMS text messages, (iii) web browsing, (iv) web logs (blogs), (v) the User's calendar, (vi) the User's “To-Do” List, (vii) one or more files attached to a message, (viii) a weather report, (ix) a Web-based article. In an exemplary embodiment, the Software Application 20 may be downloaded into the mobile communication device 10 for a nominal fee, or may be provided at no charge. The Software Application 20 may function to provide one or more audible advertisements, after one or more messages have been read aloud to the user, to offset the cost of having installed the Software Application 20. In an exemplary embodiment, the Software Application 20 may function to control the playback of a music stream, such as from an MP3 source, and may further function to provide lyrics as a musical selection is being played.

The Software Application 20 may be implemented on hardware such as a smart or dumb terminal, network computer, personal digital assistant, wireless device, smartphone, tablet, television, gaming device, music player, mobile telephone, laptop, palmtop, wireless telephone, information appliance, workstation, minicomputer, mainframe computer, or other computing device, that is operated as a general purpose computer or a special purpose hardware device that can execute the functionality described herein. The Software Application 20 may be implemented on a general purpose computing device in the form of a computer including a processing unit, a system memory, and a system bus that couples various system components including the system memory to the processing unit.

The described systems may include a plurality of software processing modules stored in a memory and executed on a processor in the manner described herein. The program modules may be in the form of any or more suitable programming languages, which are converted to machine language or object code to allow the processor or processors to read the instructions. The software may be in the form of a standalone application, implemented in any suitable programming language or framework.

Method steps of the techniques described herein can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. One or more memories may store media assets (e.g., audio, video, graphics, interface elements, and/or other media files), configuration files, and/or instructions that, when executed by a processor, form the modules, engines, and other components described herein and perform the functionality associated with the components. The processor and the memory can be supplemented by, or incorporated in special purpose logic circuitry.

In various embodiments, the devices include a web browser, client application software, or both. The web browser allows the client to request a web page or other downloadable program, applet, or document (e.g., from the server(s)) with a web page request. One example of a web page is a data file that includes computer executable or interpretable information, graphics, sound, text, and/or video, that can be displayed, executed, played, processed, streamed, and/or stored and that can contain links, or pointers, to other web pages. In one embodiment, a user of the client manually requests a web page from the server. Alternatively, the device automatically makes requests with the web browser. Examples of commercially available web browser software are Microsoft® Internet Explorer®, Mozilla® Firefox®, and Apple® Safari

In some embodiments, the devices include client application software. The client application software provides functionality to the device that provides for the implementation and execution of the features described herein. The client application software may be implemented in various forms, for example, it may be in the form of a web page, widget, and/or Java, JavaScript, .Net, Silverlight, C⁺⁺, C, Flash, and/or other applet or plug-in that is downloaded to the device and runs in conjunction with the web browser. The client application software and the web browser may be part of a single client-server interface; for example, the client software can be implemented as a “plug-in” to the web browser or to another framework or operating system. Any other suitable client software architecture, including but not limited to widget frameworks and applet technology may also be employed with the client software.

A communications network may connect the devices with one or more servers and/or with each other. The communication may take place via any media such as standard telephone lines, LAN or WAN links (e.g., T1, T3, 56 kb, X.25), broadband connections (ISDN, Frame Relay, ATM), wireless links (802.11, Bluetooth, GSM, CDMA, etc.), and so on. The network may carry TCP/IP protocol communications, and HTTP/HTTPS requests made by a web browser, and the connection between the clients and servers can be communicated over such TCP/IP networks. The type of network is not a limitation, however, and any suitable network may be used.

It should also be noted that embodiments of the present invention may be provided as one or more computer-readable programs embodied on or in one or more articles of manufacture. The article of manufacture may be any suitable hardware apparatus, such as, for example, a floppy disk, a hard disk, a CD-ROM, a CD-RW, a CD-R, a DVD-ROM, a DVD-RW, a DVD-R, a flash memory card, a PROM, a RAM, a ROM, or a magnetic tape. In general, the computer-readable programs may be implemented in any programming language. The software programs may be further translated into machine language or virtual machine instructions and stored in a program file in that form. The program file may then be stored on or in one or more of the articles of manufacture. In other cases the invention may take the form of a downloadable application made available in either a public or private application platform.

Certain embodiments of the present invention were described above. It is, however, expressly noted that the present invention is not limited to those embodiments, but rather the intention is that additions and modifications to what was expressly described herein are also included within the scope of the invention. Moreover, it is to be understood that the features of the various embodiments described herein were not mutually exclusive and can exist in various combinations and permutations, even if such combinations or permutations were not made express herein, without departing from the spirit and scope of the invention. In fact, variations, modifications, and other implementations of what was described herein will occur to those of ordinary skill in the art without departing from the spirit and the scope of the invention. As such, the invention is not to be defined only by the preceding illustrative description.

What is claimed is:

1. A method for presenting an audible and visual representation of a message delivered onto a mobile device, the method comprising the steps of:
receiving an incoming electronic message at the mobile device, the incoming message comprising at least one textual component;
translating the textual component to an audio stream; and
visually presenting the textual component in synchronicity with the audio stream such that (i) the textual component scrolls across a display of the mobile device; (ii) text corresponding to a currently audible portion of the textual component is presented substantially central of the display using a first set of display characteristics, and (iii) text not corresponding to the currently audible portion of the textual component is presented using a second set of display characteristics.

2. The method of claim 1 wherein the incoming message is one of a text message, an electronic mail message, a calendar event, a document, a web page, or structured content.

3. The method of claim 1 further comprising:
audibly presenting one or more characteristics of the incoming message; and
receiving an audible user command indicating an action to be taken on the incoming message.

4. The method of claim 3 wherein the characteristics of the incoming message comprise one or more of a time of receipt of the message, a subject of the message, or a sender of the message.

5. The method of claim 3 wherein the audible presentation of the one or more characteristics is effected automatically upon arrival of the message.

6. The method of claim 3 wherein the audible user command comprises a command to read the message, a command to delete the message, a command to mark the message as read, a command to mark the message as unread, a command to move to the next message, a command to repeat the message, or a command to play the message at a slower speed.

7. The method of claim 1 wherein the visually presented textual component is limited to a specified number of lines of text.

8. The method of claim 1 wherein the visually presented textual component is limited to a specified number of words.

9. The method of claim 1 wherein the visually presented textual component is limited to a specified amount of time required to audibly present the textual component .

10. The method of claim 1 wherein the text corresponding to a currently audible portion of the textual component comprises a single word.

11. The method of claim 1 wherein the text corresponding to a currently audible portion of the textual component comprises a single horizontal line of text.

12. The method The method of claim 1 wherein the text corresponding to a currently audible portion of the textual component comprises multiple horizontal lines of text.

13. The method of claim 1 wherein the first set of characteristics comprises one or more of a selected font size, a selected font type, a selected font color, or a selected background color.

14. The method of claim 13 wherein the second set of characteristics comprises at least one modified characteristic from the first set of characteristics.

15. The method of claim 14 wherein the modified characteristic from the first set of characteristics comprises a gradient shadow effect such that the text not corresponding to the currently audible portion of the textual component is presented in a darker font color than the text corresponding to a currently audible portion of the textual component.

16. A system for presenting an audible and visual representation of a message delivered onto a mobile device, the system comprising:
a processor for executing computer-executable instructions; and
a memory for storing the computer-executable instructions, that when executed by the processor implements a message presentation application, wherein the message presentation application presents an audible representation of the message by:
receiving an incoming electronic message at the mobile device, the incoming message comprising at least one textual component;
translating the textual component to an audio stream; and
visually presenting the textual component in synchronicity with the audio stream such that (i) the textual component scrolls across a display of the mobile device; (ii) text corresponding to a currently audible portion of the textual component is presented substantially central of the display using a first set of display characteristics, and (iii) text not corresponding to the currently audible portion of the textual component is presented using a second set of display characteristics.

17. The system of claim 16 wherein the incoming message is one of a text message, an electronic mail message, a calendar event, a document, a web page, or structured content.

18. The system of claim 16 wherein the message presentation application further:
audibly presents one or more characteristics of the incoming message; and
receives an audible user command indicating user interest in the incoming message.

19. The system of claim 16 wherein the characteristics of the incoming message comprise one or more of a time of receipt of the message, a subject of the message, or a sender of the message.

20. The system of claim 16 wherein the audible presentation of the one or more characteristics is effected automatically upon arrival of the message.

21. The system of claim 16 wherein the audible user command comprises a command to read the message, a command to delete the message, a command to mark the message as read, a command to mark the message as unread, a command to move to the next message, a command to repeat the message, or a command to play the message at a slower speed.

22. The system of claim 16 wherein the visually presented textual component is limited to a specified number of lines of text.

23. The system of claim 16 wherein the visually presented textual component is limited to a specified number of words.

24. The system of claim 16 wherein the visually presented textual component is limited to a specified amount of time required to audibly present the textual component.

25. The system of claim 16 wherein the text corresponding to a currently audible portion of the textual component comprises a single word.

26. The system of claim 16 wherein the text corresponding to a currently audible portion of the textual component comprises a single horizontal line of text.

27. The system The method of claim 16 wherein the text corresponding to a currently audible portion of the textual component comprises multiple horizontal lines of text.

28. The system of claim 16 wherein the first set of characteristics comprises one or more of a selected font size, a selected font type, a selected font color, or a selected background color.

29. The system of claim 28 wherein the second set of characteristics comprises at least one modified characteristic from the first set of characteristics.

30. The system of claim 29 wherein the modified characteristic from the first set of characteristics comprises a gradient shadow effect such that the text not corresponding to the currently audible portion of the textual component is presented in a darker font color than the text corresponding to a currently audible portion of the textual component.
